(19) United States
(12) Patent Application Publication
(10) Pub. No.: US 2021/0289973 A1
(43) Pub. Date: Sep. 23, 2021

(54) THE CORE COOKER

(71) Applicant: Marvin Gaye Bowen, White Plains, NY (US)

(72) Inventor: Marvin Gaye Bowen, White Plains, NY (US)

(21) Appl. No.: 17/206,427

(22) Filed: Mar. 19, 2021

Related U.S. Application Data
(60) Provisional application No. 63/100,574, filed on Mar. 20, 2020.

(51) Int. Cl. A47J 27/00; A47J 36/32; H05B 3/08

(52) U.S. Cl. CPC A47J 27/004; A47J 2202/00; H05B 3/08; A47J 36/32

(57) ABSTRACT

A core cooker device is used for cooking food, and has a heating element adapted for insertion into food to be cooked, a temperature control device for controlling power supplied to the heating element, and a power supply for providing power to the temperature control device. The core cooker heating element has a stem portion, and the power supply includes a coaxial cable connector and an interior wire, and includes a BNC connector and an O-ring. The BNC connector is connected to the stem portion, and the coaxial cable connector is secured by threaded engagement with the BNC connector. The interior wire is connected to a heating wire at a junction of the BNC connector and the stem portion.

### CROSS REFERENCE TO RELATED APPLICATIONS

This application claims the priority of Provisional Application No. 63/100,574 filed on Mar. 20, 2020, inventor Marvin Gaye Bowen. The entire disclosure of this provisional patent application is hereby incorporated by reference thereto, in its entirety.

### STATEMENT REGARDING FEDERALLY SPONSORED RESEARCH OR DEVELOPMENT

Not applicable.

### FIELD OF THE INVENTION

The present invention relates to cooking devices and systems, which can be inserted into foods to be cooked to speed cooking. The present invention is especially useful in reducing cooking times for foods.

### BACKGROUND OF THE INVENTION

It is a problem in the art to shorten cooking time for meats and poultry, for example.

It is also a problem to cook food more evenly. Conventional cooking involving oven baking, pan frying, and broiling all cook from the outside in. However, for thicker meats such as steaks, this can result in slow cook times to avoid burning the outside while the inside of the food is still relatively uncooked or is under-cooked.

### SUMMARY OF THE INVENTION

From the foregoing, it is seen that it is a problem in the art to provide a device meeting the above requirements. According to the present invention, a device is provided which meets the aforementioned requirements and needs in the prior art.

In a further embodiment, the present invention is directed to a device that is plugged in a socket or uses battery power to transmit heat through heating coils and radiates through a metal casing up to 450 degrees Fahrenheit. A battery is provided in that case (not shown).

Furthermore, the temperature control device can be a wireless device, for example communicating by remote control or via an app on a smart phone.

The device according to the preferred embodiment has a thermostat, and a temperature gauge.

The device includes an electrical wire that has a flattened area that is also flexible and bendable to fit over pans or pot ridges and will not cause the covers or lids to be out of place too much.

The electric wire material can go inside cooking pans or pots in relatively very high temperatures (the temperatures being typical of those required for cooking meat and other foods) while cooking, and are food grade and have moisture and water resistance.

A flat version exists, that pierces into meats and can also be used to warm foods or water at concession stands.

The flat shaped version is shaped with sharp tip, and is otherwise similar to the shape of a light bulb, or a papaya. The material can be any suitable material, including for example, stainless steel, cast iron, copper, etc.

The invention preferably includes a timer and an indication sound and light that lets a user know when it done working.

This can be built in a pan with adjustable components that will allow the user to fit the device inside a turkey, for example.

And, the present invention can be used to speed up regular cooking for any other foods or keep foods warm or hot, and has a timer.

In a further embodiment, the invention can have a rechargeable battery to power it, that can last up to five hours.

Another embodiment includes a long spiked round version with skinny spikes that sticks into meats that are thick, and a flat version that is especially used for flatter meats like steaks.

The present invention is directed to a device that is plugged in a socket or uses battery power to transmit heat through heating coils and radiates through a metal casing up to 450 degrees Fahrenheit.

The device according to the preferred embodiment has a thermostat, and a temperature gauge.

The device includes an electrical wire that has a flattened area that is also flexible and bendable to fit over pans or pot ridges and will not cause the covers or lids to be out of place too much.

The electric wire material can go inside cooking pans or pots in relatively very high temperatures (the temperatures being typical of those required for cooking meat and other foods) while cooking, and are food grade and have moisture and water resistance.

A flat version exists, that pierces into meats and can also be used to warm foods or water at concession stands.

The flat shaped version is shaped with sharp tip, and is otherwise similar to the shape of a light bulb, or a papaya. The material can be any suitable material, including for example, stainless steel, cast iron, copper, etc.

The invention preferably includes a timer and an indication sound and light that lets a user know when it done working.

This can be built in a pan with adjustable components that will allow the user to fit the device inside a turkey, for example.

And, the present invention can be used to speed up regular cooking for any other foods or keep foods warm or hot, and has a timer.

In a further embodiment, the invention can have a rechargeable battery to power it, that can last up to five hours.

Another embodiment includes a long spiked round version with skinny spikes that sticks into meats that are thick, and a flat version that is especially used for flatter meats like steaks.

Other objects and advantages of the present invention will be more readily apparent from the following detailed description when read in conjunction with the accompanying drawings.

### BRIEF DESCRIPTION OF THE DRAWINGS

FIG. 1 is a front elevational view of a core cooker device according to the present invention, having a bulbous heating element.

FIG. 2 is a front elevational view of a core cooker device according to the present invention, having a heating element with multiple finger-like projections.

FIG. 3 is a front elevational view of a core cooker device according to the present invention, having a generally flat heating element which is beet-shaped and has a pointed end.

FIG. 4 is an exploded view of the elements of FIG. 1.

FIG. 5 is an enlarged view, partially broken away, showing the bulbous end of the embodiment of FIG. 1.

FIG. 6 is a view of a BNC connector, used in the embodiment of FIG. 4.

FIG. 7 is a perspective view of an O-ring used in the embodiment of FIG. 4.

FIG. 8 is a front view of a temperature control device of the embodiment of FIG. 4.

FIG. 9 is a perspective view of a connector shown in FIG. 4, for connection to the BNC connector of FIG. 6.

FIG. 10 is a perspective view, from the front and above, showing the heating element of FIG. 1.

FIG. 11 is a side elevational view showing the heating element of FIG. 10.

FIG. 12 is a perspective view, from the front and above, showing the heating element of FIG. 2.

FIG. 13 is a side view showing the heating element of FIG. 12.

FIG. 14 is a perspective view, from the front and above, showing the heating element of FIG. 3.

FIG. 15 is a side view showing the heating element of FIG. 14.

FIG. 16 is a schematic front view of the heating element of FIG. 1, showing a further embodiment wherein a heating wire extends inside the heating element.

FIG. 17 is a schematic front view of the heating element of FIG. 2, showing a further embodiment wherein a heating wire extends inside the heating element.

FIG. 18 is a schematic front view of the heating element of FIG. 3, showing a further embodiment wherein a heating wire extends inside the heating element.

### DETAILED DESCRIPTION OF THE INVENTION

FIG. 1 is a front elevational view of a core cooker device 100 according to the present invention, having a bulbous heating element 140, a temperature control device 120 for controlling current to the heating element 140, a power cord 110 for supplying power to the temperature control device 140, and a coaxial cable 122 for supplying power to the heating element 140. A BNC connector is provided to connect the coaxial cable 122 to the heating element 140.

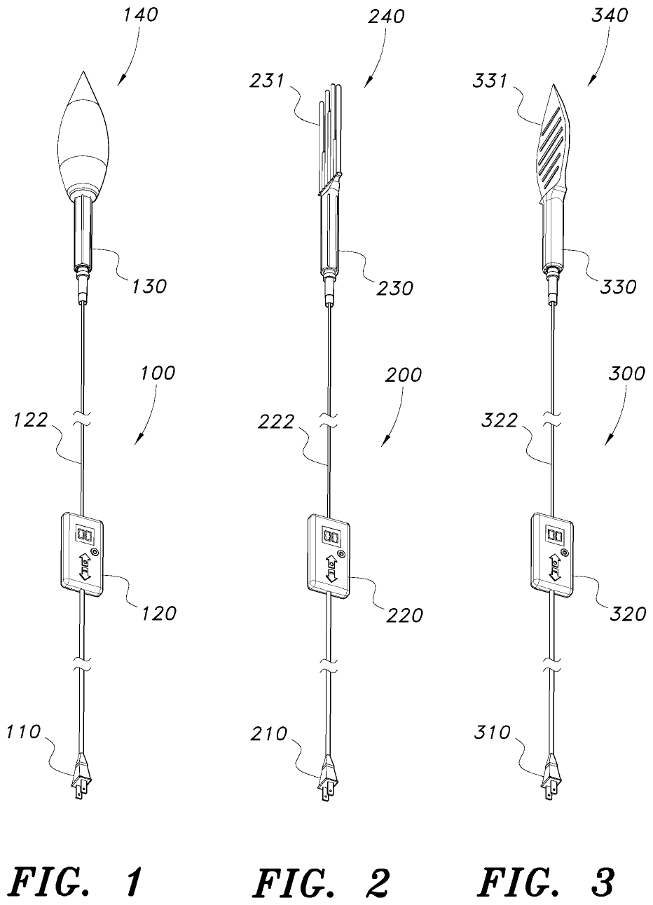

FIG. 2 is a front elevational view of a core cooker device 200 according to the present invention, having a heating element 240 with multiple finger-like projections, a temperature control device 220 for controlling current to the heating element 240, a power cord 210 for supplying power to the temperature control device 240, and a coaxial cable 222 for supplying power to the heating element 240. A BNC connector is provided to connect the coaxial cable 222 to the heating element 240. heating element with multiple finger-like projections

FIG. 3 is a front elevational view of a core cooker device according to the present invention, having a generally flat heating element which is beet-shaped and has a pointed end.

FIG. 3 is a front elevational view of a core cooker device 300 according to the present invention, having a generally flat heating element 340, a temperature control device 320 for controlling current to the heating element 340, a power cord 310 for supplying power to the temperature control device 340, and a coaxial cable 322 for supplying power to the heating element 340. A BNC connector is provided to connect the coaxial cable 322 to the heating element 340.

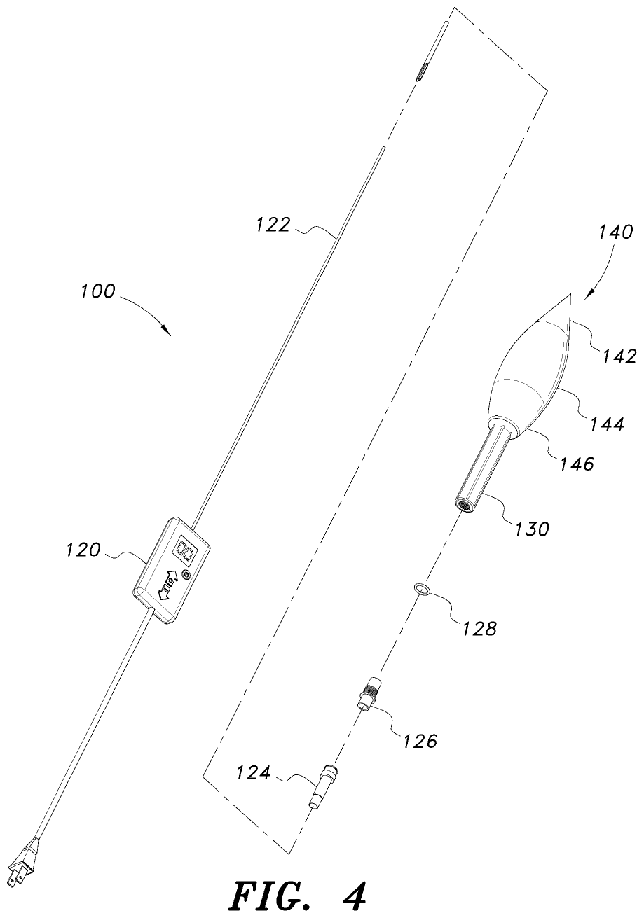

FIG. 4 is an exploded view of the elements of FIG. 1. This view also shows an O-ring 128. The temperature control device 120 is a standard commercially available device for control temperature, having an LCD screen display (showing the digits 00 in FIG. 4), a power ON/OFF button (the round element in FIG. 4), and temperature control buttons (the UP and DOWN arrows on the device 120). The bulbous heating element 140 in FIG. 4 is shown having a generally conical pointed portion 142, a middle portion 144, and a base portion 146. The base portion 146 has a stem portion 130 which connects to the coaxial cable 122. The embodiments of FIGS. 2 and 3 have similar elements, and are therefore omitted for the sake of clarity.

The heating element 140 is preferably composed of stainless steel, copper, or other suitable material that is safe for use with food; and has a heating wire therein (not shown) which is powered by the coaxial cable 122. The BNC connector 126 is used to transmit current onto the heating wire inside the metal head (which is composed of stainless steel, copper, or other suitable material that is safe for use with food) forming the heating element 140. The heating wire can be arranged in any shape, and can be of a type such as that shown in U.S. Pat. No. 7,915,567 to Lhuillier, showing therein a resistance wire inside insulating material, and being disposed inside a casing or tube. It is contemplated that a similar wire and insulating material and casing similar to that of the Lhuillier patent noted above.

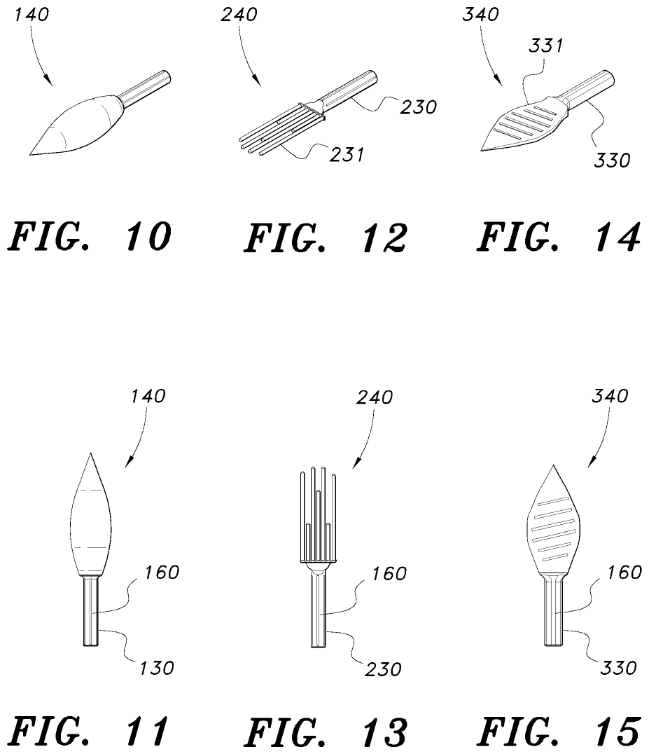

The heating wire discussed above can be arranged in any pattern inside the heating element 140. In the embodiment of FIG. 2, the individual fingers 231 (shown in FIG. 12) each have a heating wire therein, so that the individual finds 231 are heated. The heating element 340 is likewise heated internally by a heating wire as discussed above.

FIG. 5 is an enlarged view, partially broken away, showing the bulbous end of the embodiment of FIG. 1. Here, the coaxial cable connector 124 is shown having an interior wire 122 which connects to a receiving portion 150 of the BNC connector 126. A wire portion 160 extends from the BNC connector 126, and forms part of the heating wire discussed above that extends into the heating element 140.

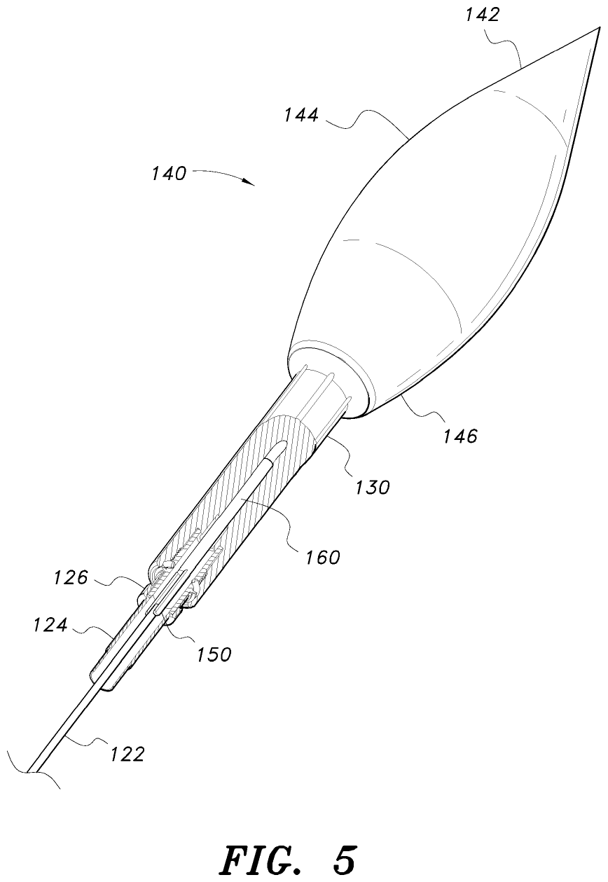

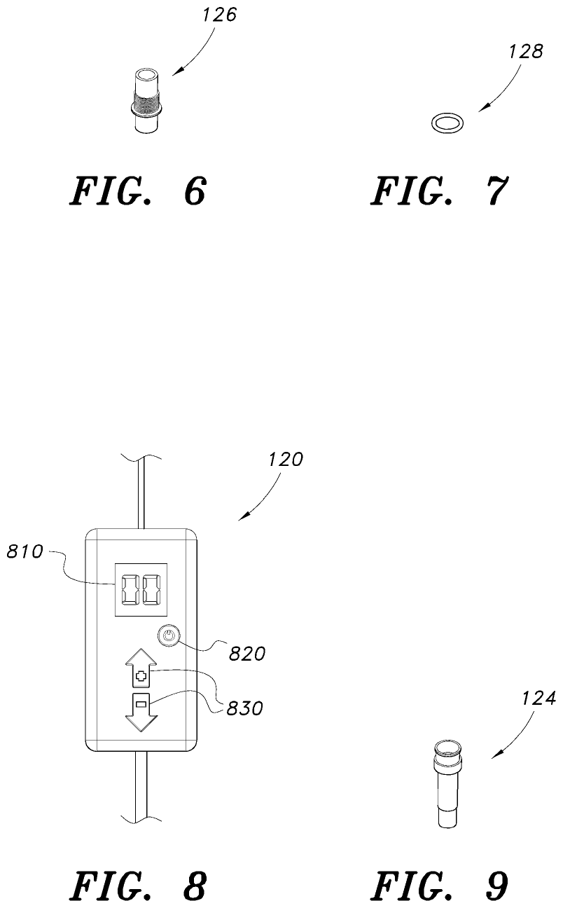

FIG. 6 is a view of the BNC connector 126, used in the embodiment of FIG. 4.

FIG. 7 is a perspective view of the O-ring 128 used in the embodiment of FIG. 4. The O-ring 128 is preferably a silicone O-ring, of a conventional commercially available type.

FIG. 8 is a front view of the temperature control device 120 of the embodiment of FIG. 4. It is described above, and can be any commercially available type of current control device, which can provide current and voltage suitable for heating the heating element 140. Embodiments of FIGS. 2 and 3 are similar, that is, devices 220 and 320 are similar to the temperature control device 120 discussed above. The device 120 includes a display screen 810 indicating temperature of the heating element 140. The device 120 also includes a power button 820 to control ON/OFF functions, and a pair of oppositely directed arrow elements 830 for manually changing the temperature setting to increase or decrease the heat provided to the heating element 140.

FIG. 9 is a perspective view of a connector 140 shown in FIG. 4, for connection to the BNC connector 126 of FIG. 6. This is a conventional connector, commercially available, and is of a type that can be used to make the connection shown in FIG. 5.

FIG. 10 is a perspective view, from the front and above, showing the heating element 140 of FIG. 1.

FIG. 11 is a side elevational view showing the heating element 140 of FIG. 10. The stem portion 130 is also shown in this view schematically in section so that the walls and interior are visible. The wire portion 160 is shown extending through the stem portion 130.

FIG. 12 is a perspective view, from the front and above, showing the heating element 240 of the embodiment of FIG. 2. In this view, the heating element 240 has the stem portion 230 (also shown in FIG. 2), along with a plurality of heating element fingers 231.

FIG. 13 is a side view showing the heating element 240 of FIG. 12. The stem portion 230 is also shown in this view schematically in section so that the walls and interior are visible. The wire portion 160 is shown extending through the stem portion 230.

FIG. 14 is a perspective view, from the front and above, showing the heating element 340 of FIG. 3. The stem portion 330 is also shown in this view, along with the flat radish or beet-shaped portion 331 having grooves thereon (unnumbered).

FIG. 15 is a side view showing the heating element 340 of FIG. 14. The stem portion 330 is also shown in this view schematically in section so that the walls and interior are visible. The wire portion 160 is shown extending through the stem portion 330.

The wire portion 160 carries heat into the heating elements (i.e., elements 140, 240, and 340). The heating elements 140, 240, and 340 are preferably composed of stainless steel, copper, or other suitable material that is safe for use with food, which has a light weight and excellent heat conducting capability. The silicone O-right 128 is used to seal the BNC connector 126 to the step 130 to keep moisture out of the heating element 140; similar connections with like O-rings are preferably made for the heating elements 240 and 340 of FIGS. 2 and 3, and those details being the same as for the embodiment of FIG. 1, those details are omitted for the sake of clarity.

The heating wire 160 is preferably composed of material like that of a soldering iron, and can withstand temperatures of 200 to 450 degrees Celsius (392 to 842 degrees Fahrenheit). The coaxial cable 122 is composed of material capable of withstanding temperatures of 200 to 450 degrees Celsius (392 to 842 degrees Fahrenheit).

Additionally, a temperature sensor wire (not shown) can be provided inside the heating wire 160 running to a temperature probe (not shown) disposed inside the heating element 140, so as to provide feedback to the display 810 of FIG. 8.

FIG. 16 is a schematic front view of the heating element 100 of FIG. 1, showing a further embodiment wherein the heating wire 160 extends inside the heating element 140. It is shown in a configuration that is exemplary, and any path can be provided so as to provide relatively uniform heating throughout the heating element 140.

FIG. 17 is a schematic front view of the core cooker 200 of FIG. 2, showing a further embodiment wherein a heating wire 160 extends inside the fingers 231 of the heating element 240. It is shown in a configuration that is exemplary, and any path can be provided so as to provide relatively uniform heating throughout the heating element 240.

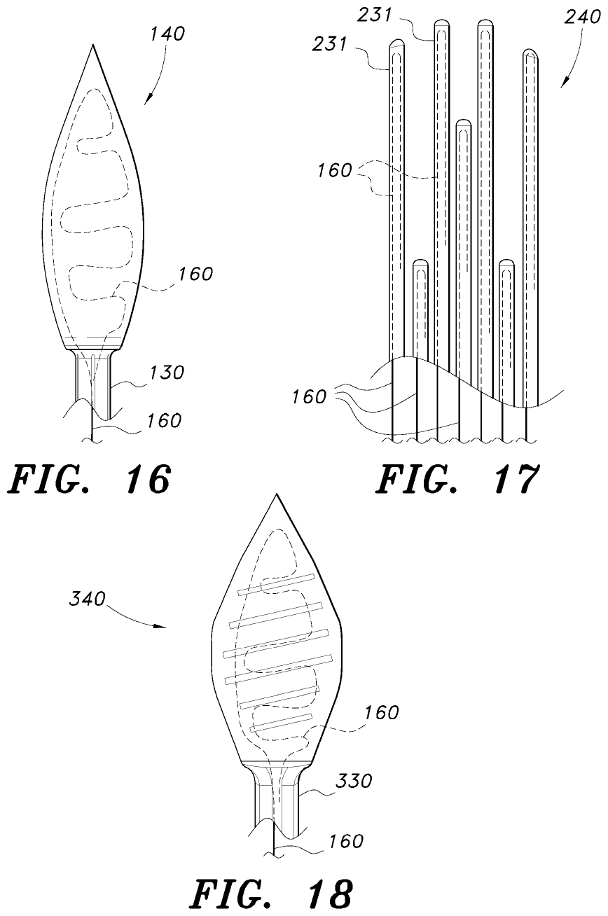

FIG. 18 is a schematic front view of the core cooker 300 of FIG. 3, showing a further embodiment wherein a heating wire 160 extends inside the heating element 340. It is shown in a configuration that is exemplary, and any path can be provided so as to provide relatively uniform heating throughout the heating element 340.

It is also contemplated that the heating elements of FIGS. 1, 2, and 3 can be interchangeably attached to the cable 122. Other heating element shapes are also contemplated as being within the scope of the present invention.

The present invention is directed to a device that is plugged in a socket or uses battery power (not shown) to transmit heat through heating coils and radiates through a metal casing up to 450 degrees Fahrenheit.

The device according to the preferred embodiment has a thermostat, and a temperature gauge, as discussed above.

The device includes an electrical wire such as wires 122 and/or 110 that has a flattened area that is also flexible and bendable to fit over pans or pot ridges and will not cause the covers or lids to be out of place too much.

The electric wire material can go inside cooking pans or pots in relatively very high temperatures (the temperatures being typical of those required for cooking meat and other foods) while cooking, and are food grade and have moisture and water resistance.

A flat version exists, that pierces into meats and can also be used to warm foods or water at concession stands.

The flat shaped version is shaped with sharp tip, and is otherwise similar to the shape of a light bulb, or a papaya. The material can be any suitable material, including for example, stainless steel, cast iron, copper, etc.

The invention preferably includes a timer and an indication sound and light that lets a user know when it done working.

This can be built in a pan with adjustable components that will allow the user to fit the device inside a turkey, for example.

And, the present invention can be used to speed up regular cooking for any other foods or keep foods warm or hot, and has a timer.

In a further embodiment, the invention can have a rechargeable battery to power it, that can last up to five hours. A battery is provided in that case (not shown).

Furthermore, the temperature control device can be a wireless device, for example communicating by remote control or via an app on a smart phone.

Another embodiment includes a long spiked round version with skinny spikes that sticks into meats that are thick, and a flat version that is especially used for flatter meats like steaks.

The invention being thus described, it will be evident that the same may be varied in many ways by a routineer in the applicable arts. Such variations are not to be regarded as a departure from the spirit and scope of the invention and all such modifications are intended to be included within the scope of the claims.

What is claimed is:

1. A core cooker device for use in cooking food, comprising:
a heating element adapted for insertion into food to be cooked;
a temperature control device for controlling power supplied to said heating element; and
a power supply for providing power to said temperature control device.

2. The core cooker device of claim 1, further comprising a coaxial cable mounted to receive power from said temperature control device, for supplying power to the heating element.

3. The core cooker device of claim 2, further comprising a BNC connector which connects said coaxial cable to said heating element.

4. The core cooker device of claim 1, wherein said heating element has a stem portion; and further comprising a coaxial cable mounted in said stem portion to receive power from said temperature control device, for supplying power to the heating element.

5. The core cooker device of claim 4, further comprising a BNC connector which connects said coaxial cable to said heating element.

6. The core cooker device of claim 1, wherein said heating element has a stem portion, and wherein said power supply includes a coaxial cable connector and an interior wire; and further comprises a BNC connector and an O-ring, said BNC connector being connected to said stem portion, and said coaxial cable connector being secured by threaded engagement with said BNC connector, and said O-ring being disposed between said BNC connector and said stem portion; and said interior wire being connected to said heating wire at a junction of said BNC connector and said stem portion.

7. The core cooker of claim 1, wherein said heating element has any of the shapes (a) turnip-shaped, (b) comb-like shape with fingers, and (c) a flat body which is a generally spade shaped.

8. The core cooker device of claim 1, further comprising an LCD display in the temperature control device.

9. The core cooker device of claim 1, further comprising a timer and an alarm in the temperature control device.
